(19) United States
(12) Patent Application Publication
(10) Pub. No.: US 2012/0161665 A1
(43) Pub. Date: Jun. 28, 2012

(54) PRECISION LIGHT CONTROL APPARATUS AND METHODS

(76) Inventor: Tom William Thornton, North Vancouver (CA)

(21) Appl. No.: 12/977,776

(22) Filed: Dec. 23, 2010

(51) Int. Cl. H05B 37/02

(52) U.S. Cl. 315/291

(57) ABSTRACT

A method of controlling an illumination apparatus comprises monitoring a dimmer modulated control voltage, controlling the illumination apparatus in a normal mode wherein changes in the dimmer modulated control voltage adjust a light output of the illumination apparatus within a normal range until the dimmer modulated control voltage manifests a first mode change condition, and, when the dimmer modulated control voltage manifests the first mode change condition, switching from the normal mode to a deep dimming mode wherein changes in the dimmer modulated control voltage adjust the light output of the illumination apparatus within a deep dimming range which is smaller than the normal range.

### TECHNICAL FIELD

The invention relates to control of lighting devices.

### BACKGROUND

Lighting devices are often connected to dimmers to provide control over the intensity of light emitted from the lighting devices. Many existing dimmers provide a single user control device, such as a knob, slider, or the like, with which to control light intensity.

The inventor has determined a need for improved apparatus and methods for controlling the intensity of light emitted from lighting devices using existing dimmers.

### SUMMARY

One aspect provides a method of controlling an illumination apparatus. The method comprises monitoring a dimmer modulated control voltage, controlling the illumination apparatus in a normal mode wherein changes in the dimmer modulated control voltage adjust a light output of the illumination apparatus within a normal range until the dimmer modulated control voltage manifests a first mode change condition, and, when the dimmer modulated control voltage manifests the first mode change condition, switching from the normal mode to a deep dimming mode wherein changes in the dimmer modulated control voltage adjust the light output of the illumination apparatus within a deep dimming range which is smaller than the normal range.

Another aspect provides a control system for an illumination apparatus. The control system comprises an input for receiving a dimmer modulated control voltage and an output for selectively controlling a light output of the illumination apparatus. The control system is configured to monitor the dimmer modulated control voltage, and switch from a normal mode to a deep dimming mode when the dimmer modulated control voltage manifests a first mode change condition. In the normal mode the control system is configured to control the light output of the illumination apparatus within a normal range, and in the deep dimming the control system is configured to control the light output of the illumination apparatus within a deep dimming range which is smaller than the normal range.

Further aspects and details of example embodiments are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic view of a LED-based illumination apparatus according to an example embodiment.

FIG. 1A is a schematic view of an incandescent illumination apparatus according to an example embodiment.

FIG. 1B is a block diagram of a LED-based illumination apparatus with a built in control system according to an example embodiment.

FIG. 1C is a schematic view of a LED-based illumination apparatus controlled with a DC dimmer according to an example embodiment.

FIG. 2 is a flow chart of a method for controlling an illumination apparatus according to an example embodiment.

FIG. 3A is a state diagram illustrating the operation of a control system for an illumination apparatus according to an example embodiment.

FIG. 3B is a state diagram illustrating the operation of a control system for an illumination apparatus according to an example embodiment.

FIGS. 4A-4D are graphs illustrating how dimmer control positions may be mapped to different ranges of luminous flux in different operating modes according to various example embodiments.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

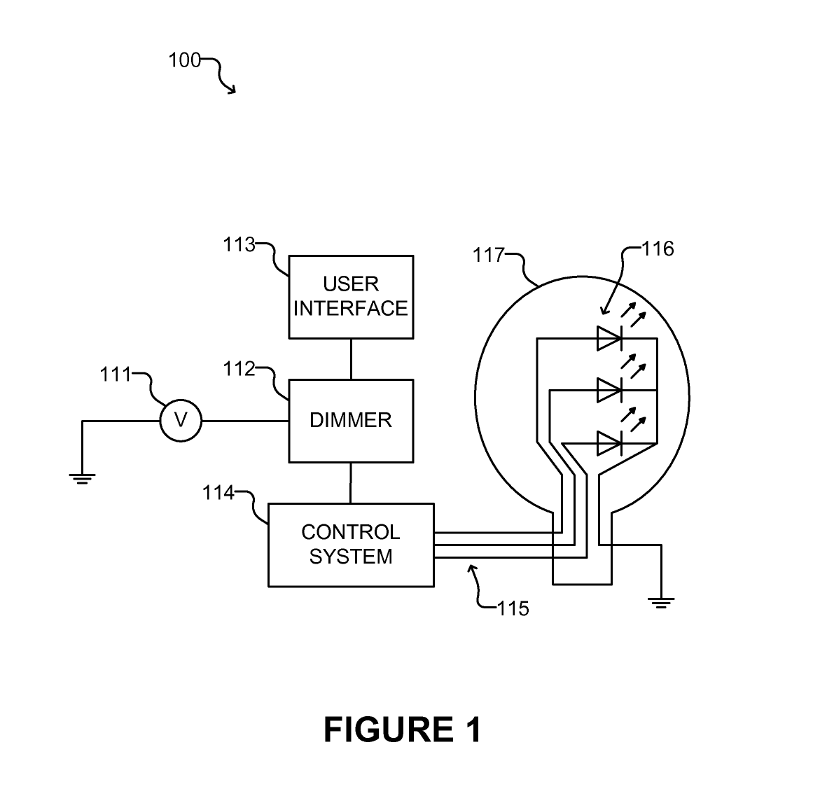

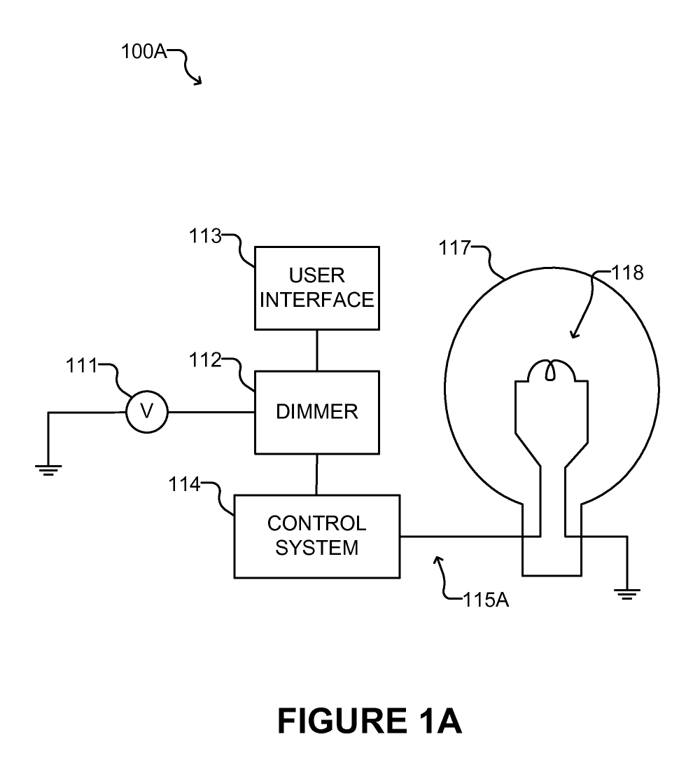

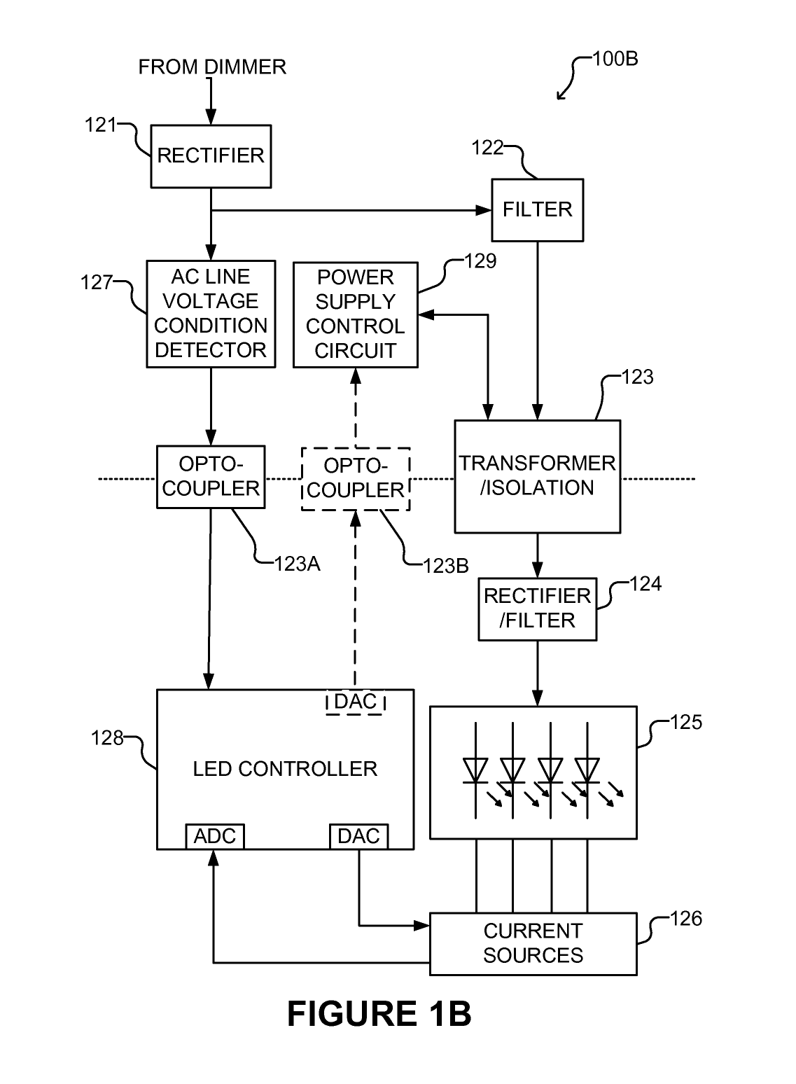

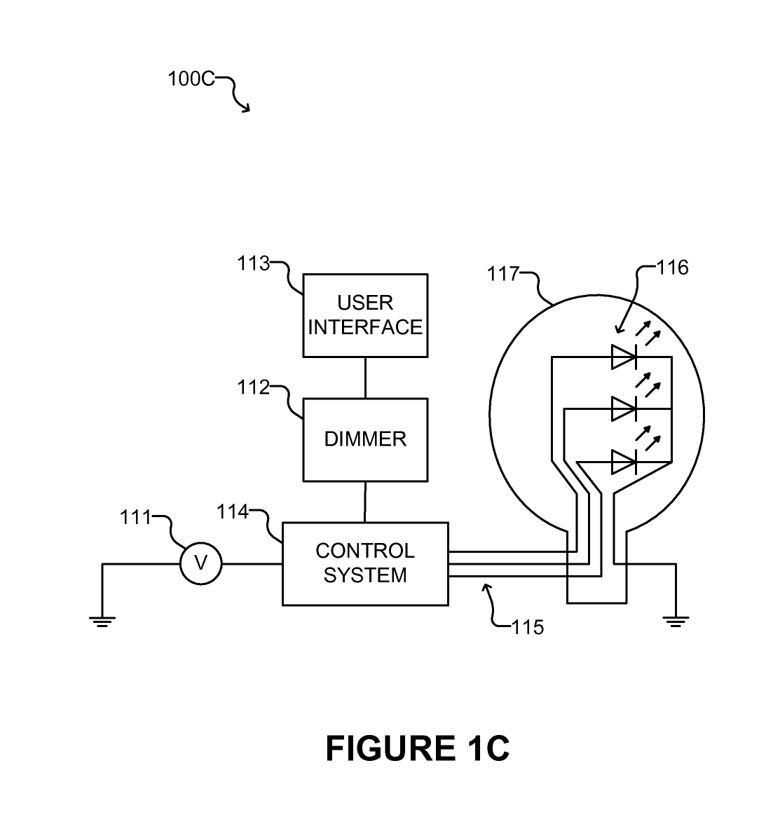

FIG. 1 shows an illumination apparatus 100 according to an example embodiment. An input voltage 111 is provided to a dimmer 112. The dimmer 112 modulates the input voltage 111 according to input from a user interface 113. Dimmer 112 may comprise any type of dimmer, including, for example and without limitation, a leading-edge phase-cut AC dimmer, a trailing-edge phase-cut AC dimmer, a dimmer which modulates the amplitude of an AC voltage, or a dimmer which modulates the magnitude of a DC voltage (e.g. 0-10V, 1-10V). In some embodiments which use a DC dimmer, input voltage 111 may be provided directly to control system 114 instead of through dimmer 112, with dimmer 112 providing only a control voltage to control system 114 based on input from user interface 113. FIG. 1C shows an example illumination apparatus 100C according to such an embodiment. Returning to FIG. 1, User interface 113 may comprise, for example, a knob, a dial, a slider, a lever, a touchpad, an array of switches, an audio-controlled interface, a light-controlled interface, a computer-controlled interface, or any other type of interface. The dimmer-modulated voltage is provided to a control system 114. In the illustrated embodiment, control system 114 provides output DC voltages 115 to a plurality of LEDs 116 packaged together in a lighting instrument 117. In other embodiments, lighting instrument 117 may comprise other types of non-LED lighting devices, and control system 114 may provide different types of output voltages for controlling such lighting devices. For example, FIG. 1A shows an illumination apparatus 100A similar to apparatus 100 of FIG. 1 except that lighting instrument 117 comprises an incandescent light bulb having a filament 118 and control system 114 provides an output AC voltage 115A to filament 118. In general, control system 114 may be configured to control any type of dimmable lighting instrument. The term “lighting instrument” as used herein is to be understood to refer to any type of apparatus which emits light including, for example and without limitation, luminaires, lamps, light bulbs, etc.

The term “LED” as used herein is to be understood to include any electroluminescent diode or other type of carrier injection/junction-based component that generates electromagnetic radiation in response to an electrical signal, including, without limitation, semiconductor-based structures that emit light in response to current, light emitting polymers, electroluminescent structures, and the like. The term LED may refer to any type of light emitter (including semi-conductor and organic light emitting diodes) that generate radiation in the visible, infrared and/or ultraviolet spectrums. Also, the term LED does not necessarily imply a particular type of physical and/or electrical package. For example, the term LED may refer to a single light emitting device having multiple elements that may or may not be individually controllable that are configured to respectively emit different spectra of radiation. Also, a LED may include a phosphor that is considered as part of the LED (as in, for example, some white LEDs). The term LED may refer to, for example and without limitation, packaged LEDs including T-package mount LEDs, radial package LEDs, and power package LEDs, non-packaged LEDs, surface mount LEDs, chip-on-board LEDs, LEDs with casings and/or optical elements such as, for example, diffusing lenses, etc.

Control system 114 is connected to receive a control voltage as modulated by dimmer 112 and control LEDs 116 based on the control voltage. Control system 114 may control LEDs 116 individually or in groups. Control system 114 is configured to switch between two or more operating modes. In some embodiments, control system 114 is configured to selectively control the intensity of light emitted from LEDs 116 over a different range in each mode, as described below.

In some embodiments, control system 114 is configured to control the intensity of light output by an individual LED 116 or group of LEDs 116 by varying the level of current with which that LED or group is driven. In some embodiments, control system 114 is configured to control the intensity of light output by an LED or group by varying the duty cycle for that LED or group. In some embodiments, control system 114 is configured to control the intensity of light output by an LED or group by varying both the current level and duty cycle of the driving current.

In some embodiments, control system 114 is separate from lighting instrument 117. In some embodiments control system 114 is partially or wholly combined into lighting instrument 117. For example, in some embodiments control system 114 and lighting instrument 117 are packaged together and configured to fit into a socket designed to receive an incandescent light bulb.

FIG. 1B shows a LED-based illumination apparatus 100B having a built in control system according to an example embodiment. Apparatus 100B comprises a rectifier 121 which receives modulated AC line voltage from an AC dimmer (not shown in FIG. 1A) as the control voltage. The output of rectifier 121 is passed through a filtering circuit 122, a transformer 123, and then a further rectifying/filtering circuit 124 to provide voltage for use by LEDs 125. Current sources 126 regulate the current passed through LEDs 125 in response to a control signal received from a LED controller 128. Controller 128 also measures the voltage drop across current sources 126.

An AC line voltage condition detector 127 also receives the output of rectifier 121 and provides a signal indicative of AC line voltage conditions to controller 128 through opto-coupler 123A. A power supply control circuit 129 controls transformer 123 to regulate the voltage provided to LEDs 125. Power supply control circuit 129 may receive an LED voltage control signal from controller 128 through opto-coupler 123B, and control transformer 123 based on the LED voltage control signal from controller 128. However, it is not necessary for power supply control circuit 129 to receive an LED voltage control signal from controller 128 in some embodiments, as indicated by the use of dashed lines to represent the LED voltage control signal and opto-coupler 123B in FIG. 1B. In some embodiments, power supply control circuit 129 may receive a different type of feedback from controller 128. Transformer 123 and opto-couplers 123A and 123B provide isolation from AC line voltage for rectifier/filter 124, LEDs 125, current sources 126 and controller 128. In other embodiments, isolation may be provided by elements other than transformer 123 and opto-couplers 123A and 123B, such as, for example and without limitation, capacitors, digital isolators, magneto-isolators, isolation amplifiers, signal transfer devices having transmitters and receivers that are electrically isolated from one another and exchange signals such as optical, radio, or ultrasound signals or the like.

Controller 128 may, for example, comprise a processor and memory storing instructions which configure the processor to carry out methods for controlling LEDs based on the dimmer modulated AC line voltage according to various embodiments. Controller 128 may also have memory allocated for storing values representative of dimmer modulated AC line voltage conditions for future use by the processor. Controller 128 is connected to receive various signals. Where the signals include analog signals then controller 128 may comprise an analog to digital converter. In the illustrated embodiment, controller 128 comprises an analog to digital converter (not specifically enumerated) for receiving analog signals from current sources 126. The analog to digital converter may optionally or in the alternative be connected to convert analog signals from other sources into a digital format. In the illustrated embodiment controller 128 comprises digital to analog converters (not specifically enumerated) for sending analog signals to current sources 126 and power supply control circuit 129.

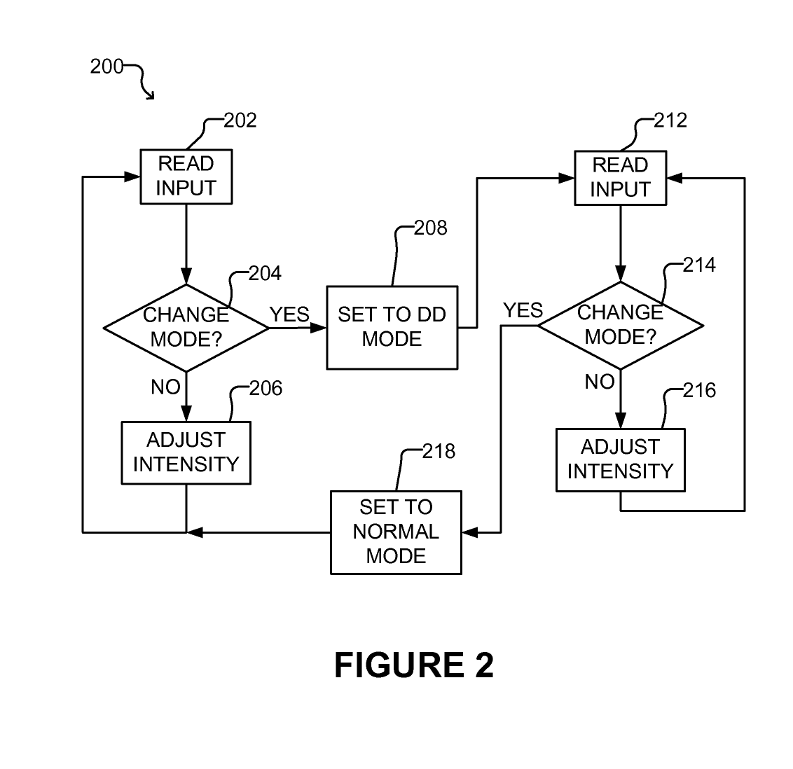

FIG. 2 shows a method 200 according to an example embodiment which a control system for an illumination apparatus (such as, for example, control system 114) may be configured to execute. An input is read at step 202. The input may be, for example, a control voltage such as a dimmer modulated AC voltage signal, a dimmer modulated DC voltage signal, another power-related signal from an AC or DC source, a signal derived from either thereof, or the like. In some embodiments, the input is read continuously or periodically throughout operation of method 200.

At step 204 the control system determines if the input manifests a mode change condition. A mode change condition may comprise, for example:
a particular instantaneous signal value;
a time averaged signal value;
a interruption of signal for a pre-determined time;
a particular rate of change of signal value;
a particular time-dependent pattern of change in signal value;
a particular time-independent pattern of change in a signal value;
a combination thereof; and/or
other conditions.

In some embodiments, a mode change may be indicated by a parameter of a dimmer modulated AC line voltage (such as, for example, the phase cut angle or the amplitude) or a parameter of a dimmer modulated DC voltage (such as, for example, the magnitude) transitioning across a threshold a predetermined number of times in a predetermined time period. For example, in some embodiments, a mode change condition may occur when the parameter transitions from below to above to below to above to below 90% of its maximum value within 1.5 seconds. In some embodiments, a mode change condition may occur when the parameter transitions from above to below to above 90% of its maximum value within 1.5 seconds (e.g. in a “V” pattern″), or above to before to above to below to above 90% of its maximum value within 1.5 seconds (e.g. a “W” pattern). Such “V” and “W” patterns may be desirable in some embodiments wherein the dimmer control has a physical end stop at the upper end of its range, such that the user can easily locate the starting point of a mode change initiation pattern. Other numbers of transitions, threshold levels, and/or time periods may indicate a mode change condition in other embodiments. In some embodiments, different thresholds may be used for detecting upward and downward transitions, wherein a slightly higher threshold is used for detecting upward transitions and a slightly lower threshold is used for detecting downward transitions. In some embodiments, the threshold level may be selected based on the current value of the parameter, such that a user may trigger a mode change by performing the same pattern of actions regardless of the current position of the user interface.

As long as the input does not manifest a mode change condition (step 204 NO output), method proceeds to step 206. At step 206 the overall intensity of light emitted by the LEDs of the lighting instrument is adjusted according to the input. The intensity at step 206 is adjustable over a “normal” range of intensities, which may correspond to the full range of intensities achievable by the illumination apparatus.

In some embodiments, the control system may sample the control voltage at a first rate for adjusting the intensity of light emitted by the LEDs and at a second rate for detecting mode change conditions. The second rate is less than the first rate in some embodiments. For example, in some embodiments the first rate is 120 Hz and the second rate is 60 Hz.

In some embodiments, step 204 of monitoring the input for mode change conditions and step 206 of adjusting intensity according to the input occur substantially simultaneously. For example, step 204 may be implemented as a background task, such that detection of mode change conditions occurs in parallel with intensity adjustment.

If the input does manifest a mode change condition (step 204 YES output), method 200 proceeds to step 208, where the control system switches to a “deep dimming” mode, wherein the range over which the intensity of light from the illumination apparatus is adjustable is a sub-range of the normal range, as described below. In the deep dimming mode, adjustment of the control voltage provided to the input across its full range of values (e.g. by operating the user interface through it's full range of control positions) causes the intensity of light from the illumination apparatus to vary over a smaller range than the full range of intensities achievable by the illumination apparatus, such that a maximum control voltage value corresponds to less than a maximum light intensity.

In some embodiments, the lower end of the sub-range may correspond to zero light intensity. In some embodiments, the lower end of the sub-range may correspond to a non-zero light intensity. In embodiments wherein the only power available for operating the illumination apparatus is provided by a dimmer modulated control voltage, and adjustment of the user interface to the a minimum control position results in a substantially zero control voltage (such as is typically the case for phase-cut AC dimmers), the lower end of the sub-range will necessarily correspond to zero light intensity. In embodiments wherein the illumination apparatus receives power other than through the dimmer modulated control voltage (such as is typically the case for DC dimmers), the lower end of the sub-range may correspond to either a zero or a non-zero light intensity.

After step 208, method 200 proceeds to step 212, where the input is read. It will be understood that the inputs read at steps 202 and 212 may be supplied by the same source (e.g., a single dimmer-modulated AC or DC voltage), and that they are shown separately in FIG. 2 to make the explanation of method 200 more easily comprehensible. In some embodiments, the inputs read at steps 202 and 212 are combined into a single physical input. In some embodiments, the inputs read at steps 202 and 212 are implemented as distinct physical inputs. The inputs read at steps 202 and 212 may be sampled at the same rate, or may be sampled at different rates, as discussed above.

At step 214 the control system determines if the input manifests a mode change condition. Monitoring for a mode change condition at step 214 may be substantially similar to step 204 described above. In some embodiments, the same input conditions may indicate a mode change at both steps 204 and 214. In some embodiments, different input conditions may indicate mode changes at steps 204 and 214.

As long as the input does not manifest a mode change condition (step 214 NO output), method proceeds to step 216. At step 216 the overall intensity of light emitted by the LEDs of the lighting instrument is adjusted according to the input. The intensity at step 216 is adjustable over a sub-range of intensities, which is smaller than the full range of intensities achievable by the illumination apparatus.

In some embodiments, similar to the normal mode discussed above, in the deep dimming mode the control system may sample the control voltage at a first rate for adjusting the intensity of light emitted by the LEDs and at a second rate for detecting mode change conditions. The second rate is less than the first rate in some embodiments. For example, in some embodiments the first rate is 120 Hz and the second rate is 60 Hz.

In some embodiments, step 214 of monitoring the input for mode change conditions and step 216 of adjusting intensity according to the input occur substantially simultaneously. For example, step 214 may be implemented as a background task, such that detection of mode change conditions occurs in parallel with intensity adjustment.

If the input does manifest a mode change condition (step 214 YES output), method 200 proceeds to step 218, where the control system switches to the normal mode. After step 218 method 200 and then returns to step 202.

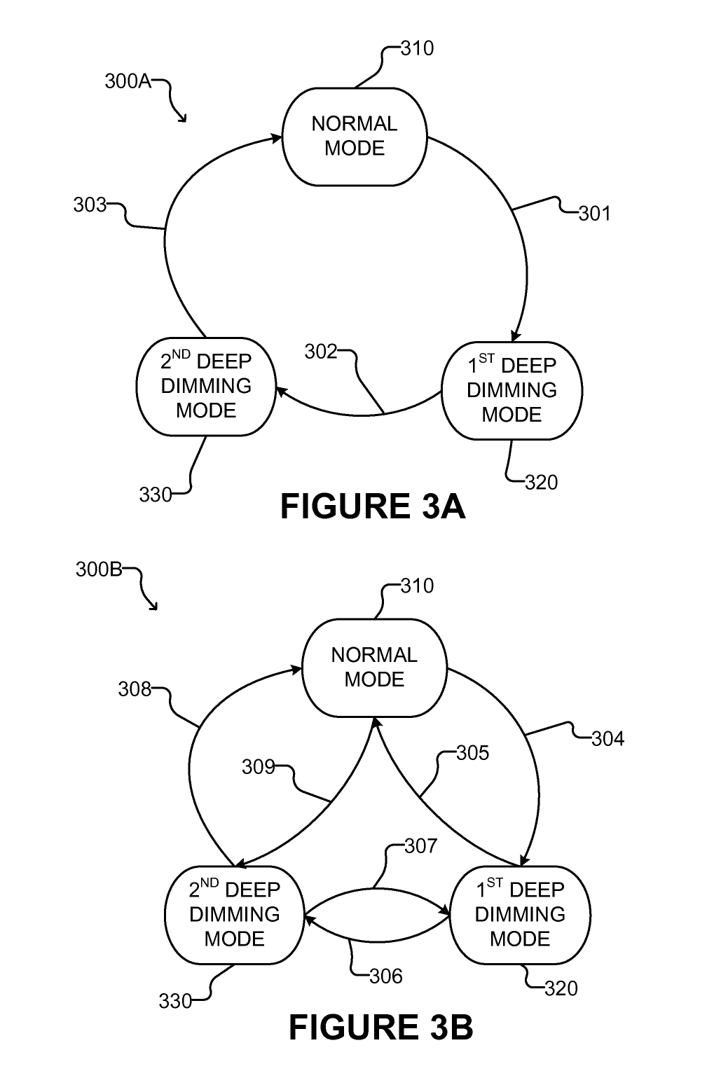

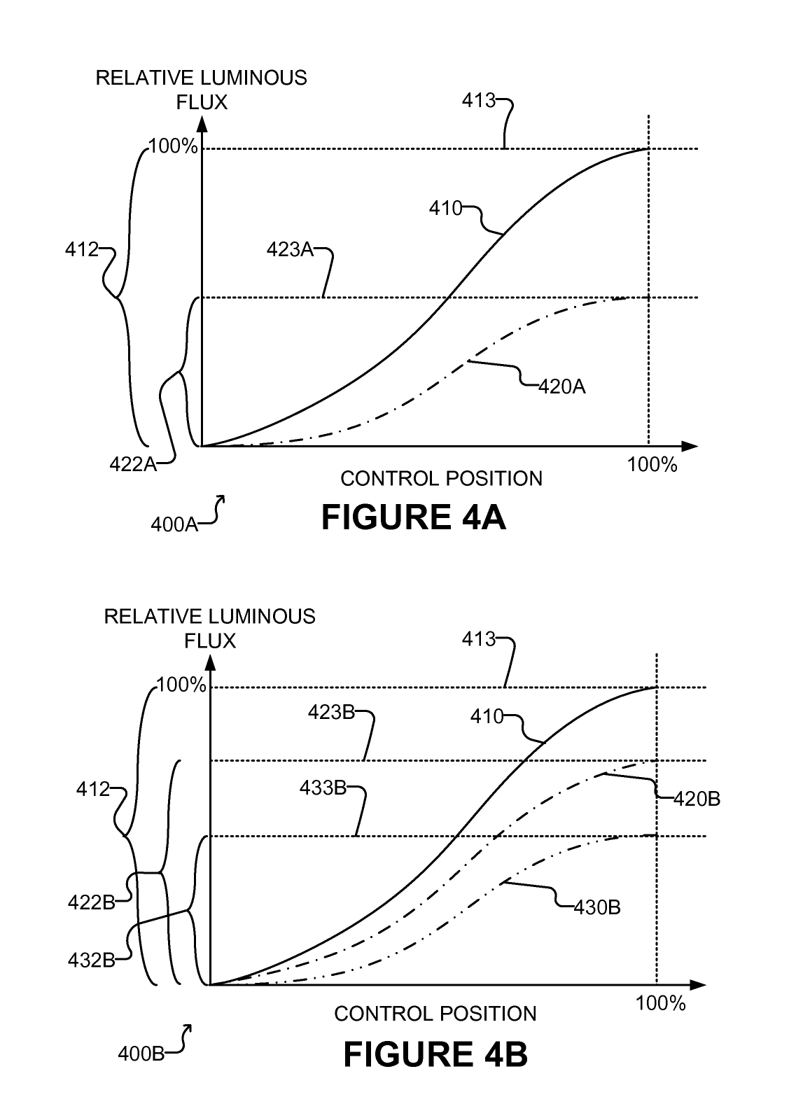

FIGS. 3A and 3B respectively show state diagrams 300A and 300B which illustrate the operation of illumination apparatus control systems implementing methods according to an example embodiments. In each of FIGS. 3A and 3B, the control system may is operable in a normal mode 310, a first deep dimming mode 320, and a second deep dimming mode 330. In normal mode 310, the intensity of light emitted by the illumination apparatus is adjustable over a “normal” range of intensities, which may correspond to the full range of intensities achievable by the illumination apparatus. In first deep dimming mode 320, the intensity of light emitted by the illumination apparatus is adjustable over a first sub-range of intensities. In second deep dimming mode 330, the intensity of light emitted by the illumination apparatus is adjustable over a second sub-range of intensities. In some embodiments, the second sub-range of intensities may comprise a subset of the first sub-range of intensities. In some embodiments, the first sub-range of intensities may comprise a subset of the second sub-range of intensities. In some embodiments, the first and second sub-ranges of intensities may overlap but neither is a subset of the other. In some embodiments, the first and second sub-ranges of intensities may not overlap.

In the FIG. 3A example, the control system is configured to cycle through normal mode 310, first deep dimming mode 320 and second deep dimming mode 330 in sequence. Action 301 causes the control system to transition from normal mode 310 to first deep dimming mode 320. Action 302 causes the control system to transition from first deep dimming mode 320 to second deep dimming mode 330. Action 303 causes the control system to transition from second deep dimming mode 320 to normal mode 310. Actions 301-303 may, for example, comprise operating the user interface of the dimmer to produce a mode change condition as described above. In some embodiments, actions 301-303 may each comprise different movements of the user interface. In some embodiments, actions 301-303 may each comprise the same movement(s) of the user interface, such that a user may cycle through modes 310, 320 and 330 by repeatedly performing the same movements.

In the FIG. 3B example, the control system is configured to switch to a selected one normal mode 310, first deep dimming mode 320 and second deep dimming mode 330 depending on the action performed. Action 304 causes the control system to transition from normal mode 310 to first deep dimming mode 320. Action 305 causes the control system to transition from first deep dimming mode 320 to normal mode 310. Action 306 causes the control system to transition from first deep dimming mode 320 to second deep dimming mode 330. Action 307 causes the control system to transition from second deep dimming mode 330 to first deep dimming mode 320. Action 308 causes the control system to transition from second deep dimming mode 320 to normal mode 310. Action 309 causes the control system to transition from normal mode 310 to second deep dimming mode 320. Actions 304-309 may, for example, comprise operating the user interface of the dimmer to produce a mode change condition as described above. In some embodiments, actions 304-309 may each comprise different movements of the user interface. In some embodiments, action 304 may comprise the same movement(s) of the user interface as action 307, and likewise actions 305 and 308 may comprise the same movement(s), and actions 306 and 309 may comprise the same movement(s), such that a user may select a desired one of modes 310, 320 and 330 by performing the same movement(s) of the user interface regardless of the current mode of the control system.

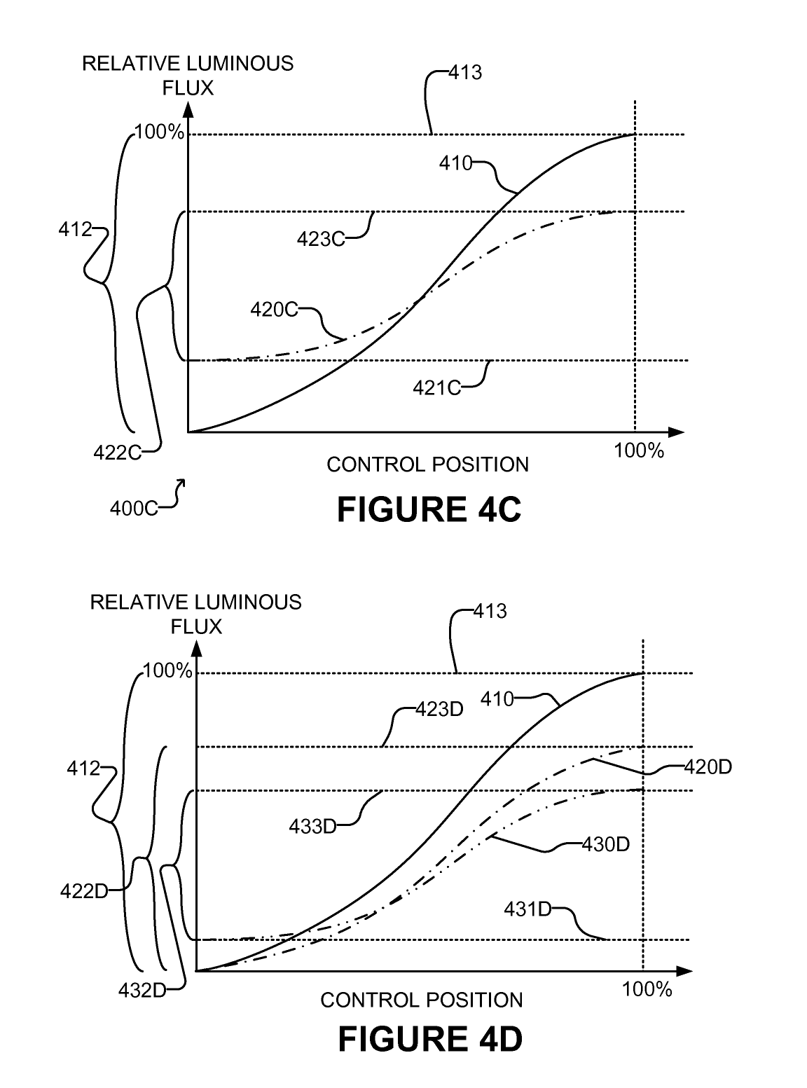

FIGS. 4A to 4D respectively show graphs 400A to 400D which illustrate how dimmer control positions may be mapped to different ranges of luminous flux in different operating modes according to various example embodiments. In each of FIGS. 4A to 4D, the vertical axis represents relative luminous flux output by an illumination apparatus, and the horizontal axis represents a control position of a user interface which controls a dimmer. Curve 410 shows an example of how relative luminous flux may vary with control position in a normal mode in some embodiments. It is to be understood that curve 410 could have different shapes in other embodiments. In the normal mode, the relative luminous flux is adjustable over a normal range 412, with a minimum control position (at the left side of the graph) generating zero luminous flux and a maximum control position (at the right side of the graph) generating a luminous flux 413 which is 100% of the maximum luminous flux achievable by the illumination apparatus. However, it is to be understood that luminous flux 413 generated at the maximum control position may have some value which is lower than 100% of the maximum luminous flux achievable by the illumination apparatus in some embodiments.

In the FIG. 4A example, curve 420A shows an example of how relative luminous flux may vary with control position in a deep dimming mode in some embodiments. It is to be understood that curve 420A could have different shapes in other embodiments. In the deep dimming mode represented by curve 420A, the relative luminous flux is adjustable over a sub-range 422A, with the minimum control position generating zero luminous flux and the maximum control position generating a luminous flux 423A which is less than 100% of the maximum luminous flux achievable by the illumination apparatus. In some embodiments, luminous flux 423A may, for example be about 50% of the maximum luminous flux achievable by the illumination apparatus, although it is to be understood that other values of luminous flux 423A are also possible.

In the FIG. 4B example, curve 420B shows an example of how relative luminous flux may vary with control position in a first deep dimming mode in some embodiments, and curve 430B shows an example of how relative luminous flux may vary with control position in a second deep dimming mode in some embodiments. It is to be understood that curves 420B and 430B could have different shapes in other embodiments. In the first deep dimming mode represented by curve 420B, the relative luminous flux is adjustable over a sub-range 422B, with the minimum control position generating zero luminous flux and the maximum control position generating a luminous flux 423B which is less than 100% of the maximum luminous flux achievable by the illumination apparatus. In the second deep dimming mode represented by curve 430B, the relative luminous flux is adjustable over a sub-range 432B, with the minimum control position generating zero luminous flux and the maximum control position generating a luminous flux 433B which is substantially less than luminous flux 423B.

In the FIG. 4C example, curve 420C shows an example of how relative luminous flux may vary with control position in a deep dimming mode in some embodiments. It is to be understood that curve 420C could have different shapes in other embodiments. In the deep dimming mode represented by curve 420C, the relative luminous flux is adjustable over a sub-range 422C, with the minimum control position generating a non-zero luminous flux 421C and the maximum control position generating a luminous flux 423A which is less than 100% of the maximum luminous flux achievable by the illumination apparatus.

In the FIG. 4D example, curve 420D shows an example of how relative luminous flux may vary with control position in a first deep dimming mode in some embodiments, and curve 430D shows an example of how relative luminous flux may vary with control position in a second deep dimming mode in some embodiments. It is to be understood that curves 420D and 430D could have different shapes in other embodiments. In the first deep dimming mode represented by curve 420D, the relative luminous flux is adjustable over a sub-range 422D, with the minimum control position generating zero luminous flux and the maximum control position generating a luminous flux 423D which is less than 100% of the maximum luminous flux achievable by the illumination apparatus. In the second deep dimming mode represented by curve 430D, the relative luminous flux is adjustable over a sub-range 432B, with the minimum control position generating a non-zero luminous flux 431D and the maximum control position generating a luminous flux 433D which is less than luminous flux 423D.

Some embodiments may be implemented in illumination apparatus which include AC-DC power supplies which receive AC power on a primary side and output DC power on a secondary side. Some such supplies operate most efficiently when their power output is within some range of their input power. For example, some power supplies have maximum efficiency when operated to output approximately 70-80% of full power. Some embodiments may provide power supplies with different secondary sides optimized for the normal and deep dimming modes. Some embodiments may provide for reconfiguration of the primary and/or secondary side (for example, by switching in different components) to optimize operation in the normal and deep dimming modes. Some embodiments may provide power supplies wherein different transformer taps are selected to optimize operation in the normal and deep dimming modes. Some embodiments may provide power supplies in which the one time is selected to optimize operation in the normal and deep dimming modes.

Some embodiments may be configured for use with thyristor-based dimmers which require at least a holding current to be drawn therethrough to maintain proper operation. Some such embodiments may include a holding current circuit configured to ensure that enough current is drawn through the dimmer to maintain proper operation.

Certain implementations of the invention comprise computer hardware, software or both hardware and software components which perform a method of the invention. For example, one or more processors in a control system for a device may implement methods as described herein by executing software instructions in a program memory accessible to the processors. Processing hardware in such embodiments may include one or more appropriately-configured programmable processors, programmable logic devices (such as programmable array logic (“PALs”) and programmable logic arrays (“PLAs”)), digital signal processors (“DSPs”), field programmable gate arrays (“FPGAs”), application specific integrated circuits (“ASICs”), large scale integrated circuits (“LSIs”), very large scale integrated circuits (“VLSIs”) or the like. As one skilled in the art will appreciate, these example embodiments are for illustrative purposes only, and methods and systems according to embodiments of the invention may be implemented in any suitable device having appropriately configured processing hardware. In some embodiments, the invention may be implemented in software. For greater clarity, “software” includes (but is not limited to) firmware, resident software, microcode, and the like. Both processing hardware and software may be centralized or distributed (or a combination thereof), in whole or in part, as known to those skilled in the art.

The invention may also be provided in the form of a computer program product accessible from a computer-readable medium for use by or in connection with processing hardware. A computer-readable medium can be any medium which carries a set of computer-readable signals comprising instructions which, when executed by processing hardware, causes the processing hardware to execute a method of the invention. A computer-readable medium may be in any of a wide variety of forms, including an electronic or semiconductor system (e.g. ROM and flash RAM), magnetic or electro-magnetic system (e.g. floppy diskettes and hard disk drives), or optical or infrared system (e.g. CD ROMs and DVDs). The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of controlling an illumination apparatus comprising:
monitoring a dimmer modulated control voltage;
controlling the illumination apparatus in a normal mode wherein changes in the dimmer modulated control voltage adjust a light output of the illumination apparatus within a normal range until the dimmer modulated control voltage manifests a first mode change condition; and
when the dimmer modulated control voltage manifests the first mode change condition, switching from the normal mode to a deep dimming mode wherein changes in the dimmer modulated control voltage adjust the light output of the illumination apparatus within a deep dimming range which is smaller than the normal range.

2. A method according to claim 1 comprising switching from the deep dimming mode to the normal mode when the dimmer modulated control voltage manifests a second mode change condition or a second occurrence of the first mode change condition.

3. A method according to claim 1 wherein the deep dimming mode comprises a first deep dimming mode and the deep dimming range comprises a first deep dimming range, the method comprising switching from the first deep dimming mode to a second deep dimming mode when the dimmer modulated control voltage manifests a second mode change condition, wherein in the second deep dimming mode changes in the dimmer modulated control voltage adjust the light output of the illumination apparatus within a second deep dimming range which is smaller than the normal range.

4. A method according to claim 3 comprising switching from the second deep dimming mode to the normal mode when the dimmer modulated control voltage manifests a third mode change condition.

5. A method according to claim 4 wherein the first, second and third mode change conditions comprise the same conditions.

6. A method according to claim 4 wherein the first, second and third mode change conditions comprise different conditions.

7. A method according to claim 6 comprising switching from the first deep dimming mode to the normal mode when the dimmer modulated control voltage manifests the third mode change condition, switching from the second deep dimming mode to the first deep dimming mode when the dimmer modulated control voltage manifests the first mode change condition, and switching from the normal mode to the second deep dimming mode when the dimmer modulated control voltage manifests the second mode change condition.

8. A method according to claim 3 wherein the second deep dimming range is smaller than the first deep dimming range.

9. A method according to claim 1 wherein the dimmer modulated control voltage comprises a phase cut AC voltage.

10. A method according to claim 1 wherein the dimmer modulated control voltage comprises a DC voltage.

11. A method according to claim 1 wherein switching from the normal mode to the deep dimming mode comprises reconfiguring a power supply of the illumination apparatus.

12. A control system for an illumination apparatus, the control system comprising an input for receiving a dimmer modulated control voltage and an output for selectively controlling a light output of the illumination apparatus, the control system configured to:
monitor the dimmer modulated control voltage; and
switch from a normal mode to a deep dimming mode when the dimmer modulated control voltage manifests a first mode change condition, wherein in the normal mode the control system is configured to control the light output of the illumination apparatus within a normal range, and wherein in the deep dimming the control system is configured to control the light output of the illumination apparatus within a deep dimming range which is smaller than the normal range.

13. A system according to claim 12 configured to switch from the deep dimming mode to the normal mode when the dimmer modulated control voltage manifests a second mode change condition or a second occurrence of the first mode change condition.

14. A system according to claim 12 wherein the deep dimming mode comprises a first deep dimming mode and the deep dimming range comprises a first deep dimming range, the system configured to switch from the first deep dimming mode to a second deep dimming mode when the dimmer modulated control voltage manifests a second mode change condition, wherein in the second deep dimming mode changes in the dimmer modulated control voltage adjust the light output of the illumination apparatus within a second deep dimming range which is smaller than the normal range.

15. A system according to claim 14 configured to switch from the second deep dimming mode to the normal mode when the dimmer modulated control voltage manifests a third mode change condition.

16. A system according to claim 15 wherein the first, second and third mode change conditions comprise the same conditions.

17. A system according to claim 15 wherein the first, second and third mode change conditions comprise different conditions.

18. A system according to claim 17 configured to switch from the first deep dimming mode to the normal mode when the dimmer modulated control voltage manifests the third mode change condition, switch from the second deep dimming mode to the first deep dimming mode when the dimmer modulated control voltage manifests the first mode change condition, and switch from the normal mode to the second deep dimming mode when the dimmer modulated control voltage manifests the second mode change condition.

19. A system according to claim 14 wherein the second deep dimming range is smaller than the first deep dimming range.

20. A system according to claim 12 wherein the dimmer modulated control voltage comprises a phase cut AC voltage.

21. A system according to claim 12 wherein the dimmer modulated control voltage comprises a DC voltage.

22. A system according to claim 12 comprising a power supply having a first configuration in the normal mode and a second configuration in the deep dimming mode.
